(19) United States
(12) Patent Application Publication
(10) Pub. No.: US 2005/0115081 A1
(43) Pub. Date: Jun. 2, 2005

(54) Electric cutter

(76) Inventor: Shu-Woan Tu, Rosemead, CA (US)

Correspondence Address: HDSL, 4331 STEVENS BATTLE LANE, FAIRFAX, VA, 22033, US

(21) Appl. No.: 10/984,453

(22) Filed: Nov. 10, 2004

(30) Foreign Application Priority Data
Nov. 27, 2003 (TW) 09221018

(51) Int. Cl. B26B 19/00

(52) U.S. Cl. 30/228

(57) ABSTRACT

An electric cutter is driven by a motor whose power is supplied from a dry battery unit, or a rechargeable battery unit accommodated in the housing of the cutter. Revolution speed of the motor is reduced by a speed reduction gear unit so as to amplify the output torque for operating a cutter. The cutting motion of the two blades of the cutter is performed by collaborated action of an eccentric shaft pin on a rotating disc and a movable arm provided for one of the two cutter blades. With this structure the cutter can be used for cutting the hard metallic wires easily and securely without the fear of hurting the user's hand.

### BACKGROUND OF THE INVENTION

1. Field of the Invention

The present invention relates to an electric cutter and more particularly, to a cutter which can cut hard materials like steel wires by powerful electrical force.

2. Description of the Prior Art

For interest to the hobbyist in homecrafts, various comprehensive tools are necessary. To meet the requirement for automation in every respect, parts of hand tools have become electrical motor operated instead of the manual type in the past. The electric drill is one of the most popular motor driven tools. However, there are still a lot of manual tools waiting to be converted into motor operation, the cutter which is used for cutting hard metallic wires in home workshop as well as for industrial application, has not yet been electrified up to now. Even how it will be convenient to have a pair of motor operated sharp scissors for flower arrangement to perform the work clean and neat, not to say how important to have a motor operated cutter for cutting hard metallic wires efficiently and securely in the industrial application.

Aiming at the defects depicted above, the present invention is to provide an ingeniously constructed electric cutter capable of operating conveniently and efficiently so as to rectify the disadvantages inherent to the convention a manually operated cutter.

### SUMMARY OF THE INVENTION

The present invention is to provide an electric cutter which can be used to easily cut the hard metallic wires.

Furthermore, the present invention is to provide an electric cutter which is simply constructed yet easy to handle and fabricate.

Accordingly, the electric cutter of the present invention includes a housing, a power supply unit, a snap switch, a motor, a speed reduction gear unit, a rotating disc, and a cutter. The housing is provided with a power supply unit at its rear end with a snap switch equipped on top of it. The snap switch is emerged out of the housing and is electrically connected to the power supply. The motor is installed in the housing and is electrically connected to the snap switch which controls the ON/OFF of the motor. The speed reduction gear unit is installed in the housing and is jointed to the output shaft of the motor so as to reduce the rotational speed of the motor thereby enlarging the output torque. The rotating disc is provided with an eccentric shaft pin. The rotating disc is also accommodated in the housing and jointed to the output shaft of the speed reduction gear unit 3 with its center portion so as to rotate together and drive the eccentric shaft pin simultaneously. The cutter whose two blades are hinged crosswise like a pair of scissors and their terminals are emerged out of the housing. The terminal of one of the two blades is fixed, whereas the other one's terminal has an extended movable arm whose end is provided with a vertically protruded stop hook mating the eccentric shaft pin of the rotating disc. A compressed spring is equipped straddling between he end portions of two blades. With a structure constructed as such, when the rotating disc rotates, its eccentric shaft pin also rotates and reciprocates up and down with respect to the stop hook which in turn causes the eccentric shaft pin to actuate the movable arm of the cutter to make up and down cutting motion. The electric cutter can be operated by a battery unit, a rechargeable battery unit (DC electricity) or AC electricity.

These features and advantages of the present invention will be fully understood and appreciated from the following detailed description of the accompanying drawings.

### BRIEF DESCRIPTION OF THE DRAWINGS

The drawings disclose and illustrative embodiment of the invention which serves to exemplify the various advantages and objects hereof, and are as follows:

FIG. 1 is a schematic view of the electric cutter of the present invention;

FIG. 2 is a plane perspective view illustrating the operation of the electric cutter of the present invention;

FIGS. 3A and 3B are three dimensional perspective views illustrating the operation of the electric cutter of the present invention; and

FIGS. 4A, 4B and 4C are downward views illustrating the operation of the electric cutter of the present invention.

### DETAILED DESCRIPTION OF THE PREFERRED EMBODIMENT

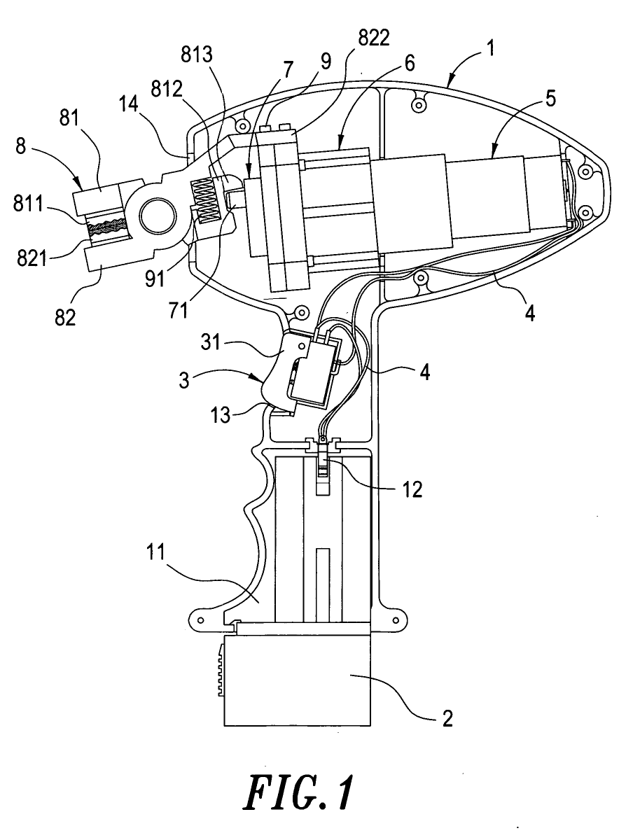

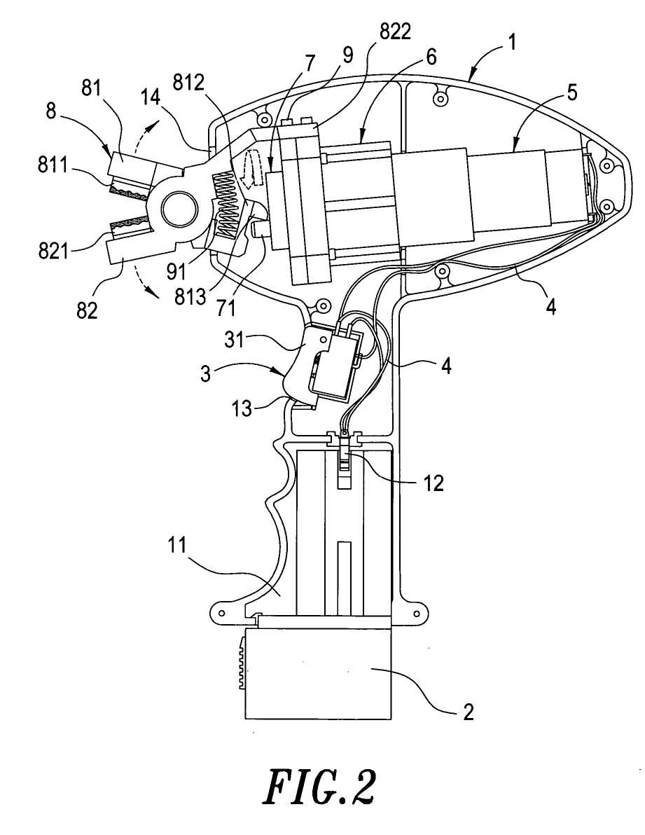

Referring to FIGS. 1 and 2, the electric cutter of the present invention comprises a housing 1, a power supply unit 2, a snap switch 3, a motor 5, a speed reduction gear unit 6, a rotating disc 7, and a cutter 8.

The housing 1 has an accommodation space 11 at its rear end, and a conductor blade 12 is provided on top of the accommodation space 11. An aperture 13 is provided at the middle section of the housing 1 and a port 14 is opened at its front end.

The power supply unit 2 which may be a battery unit or a rechargeable battery unit, is accommodated in the accommodation space 11 to durably supply sufficient power to the electric cutter by contacting the terminal of the power supply unit 2 with the conductor blade 12. The power supply unit 2 is hooked tightly onto the housing 1 so that it is securely settled in the accommodation space 11. The power supply unit 2 can also connect with a pin by an electric wire, and supply sufficient power to the electric cutter by AC electricity.

The snap switch 3 is attached to the inner wall of the housing 1 with its snap button 31 emerged out of the aperture 13 formed on the middle section of the housing 1. The snap switch 3 is connected to the conductor blade 12 with conductors 4 so as to get power supply.

The motor 5 is installed in the housing 1 and electrically connected to the snap switch 3 with the conductors 4 so that ON/OFF of the motor 5 can be controlled by operating the snap button 31 of the snap switch 3.

The speed reduction gear unit 6 is also installed in the housing 1 with its input terminal jointed to the output shaft of the motor 5 so as to be driven by the motor 5 and reduce its rotational speed, and as a reward, obtain a larger torque.

The rotating disc 7 with an eccentric shaft pin 71 is accommodated in the housing 1. The center portion of the rotating disc 7 is jointed to the output shaft of the speed reduction gear unit 6 so that the rotating disc 7 is able to revolve along with the output terminal of the speed reduction gear unit 6.

The cutter 8 is formed of a first and a second blades 81 and 82 hinged crosswise like a pair of scissors. Both blade faces 811 and 821 are emerged out of the housing 1 through the port 14, and a locked arm 822 attached to the rear end of the second blade 82 is fastened to the speed reduction gear unit 6 with a locking device 9, whereas a movable arm 812 is vertically extended from the rear end of the first blade 81. The movable arm 812 has a stop hook 813 vertically protruded from its end to mate the eccentric shaft pin 71 of the rotating disc 7. A compressed spring 91 is equipped in the manner straddling between the locked arm 822 and the movable arm 812 so as to keep the two blades 81, 82 in opened state by the tensile force of the spring 91.

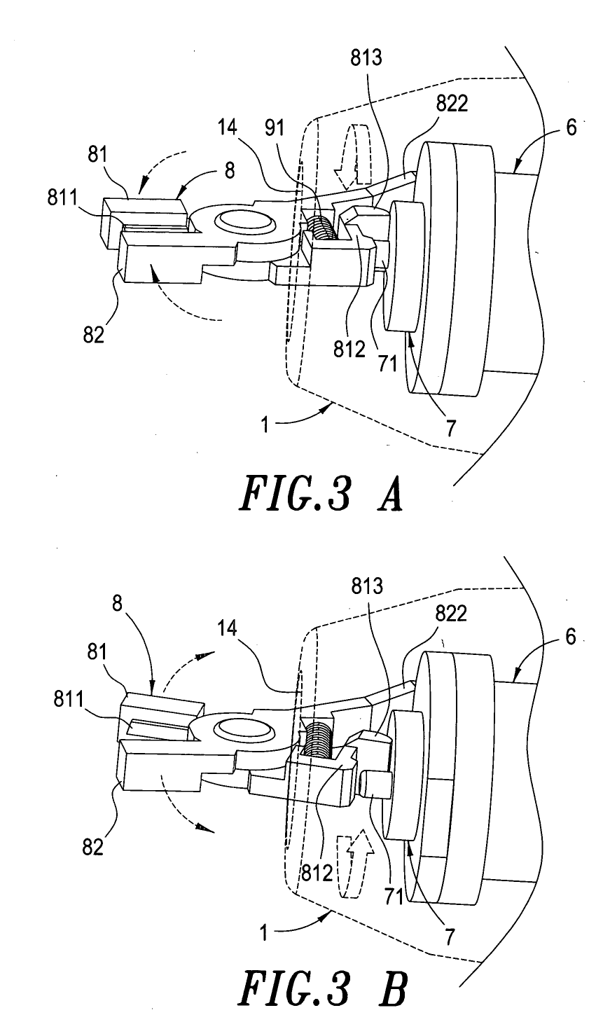

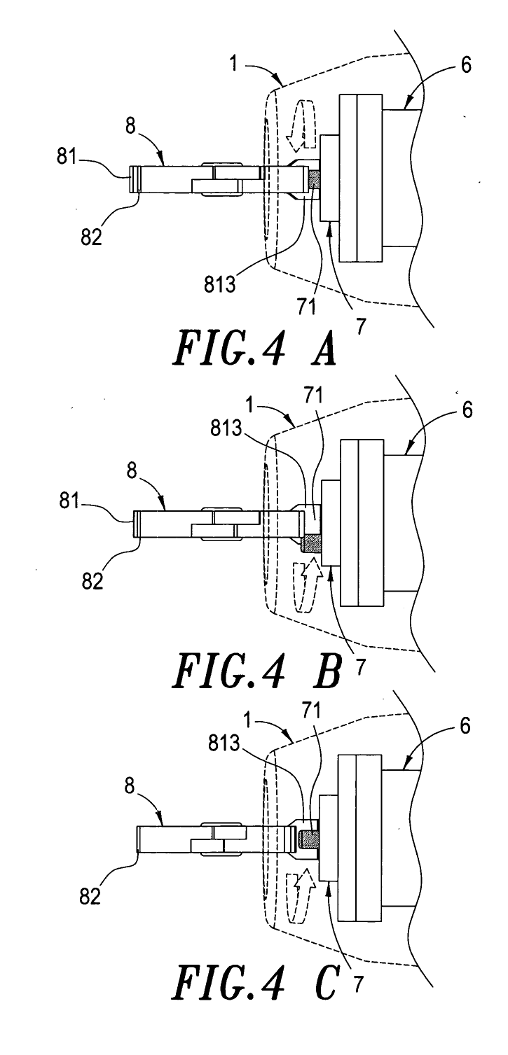

To understand the operational principle of the electric cutter of the present invention, please refer to FIGS. 3A, 3B, 4A, 4B and 4C. For using the electric cutter, press the snap button 31 of the snap switch 3 to On so as to input the power from the power supply unit 2 to the motor 5, the rotational speed of the motor 5 is reduced by the speed reduction gear unit 6 to drive the rotating disc 7 with reduced rpm but amplified torque. At this instant the eccentric shaft pin 71 of the rotating disc 7 revolves simultaneously so as to forcibly mates the stop hook 813 protruded from the end of the movable arm 812 that causes the blades 81, 82 of the cutter 8 and the compressed spring 912 to keep in closed and compressed states. When the eccentric shaft pin 71 gradually revolves downwards, the stop hook 813 also moves downwards by the resilient force of the spring 91 and finally mates forcibly with the eccentric shaft pin 71. When the eccentric shaft pin 71 gradually revolves upwards, the stop hook 813 also moves upwards to compress the spring 91. In the is manner, the stop hook 813 always keeps mating with the eccentric shaft pin 71 when the latter revolves up and down without separation thereby driving the movable arm 812 of the first blade 81 to reciprocate up and down to perform cutting operation.

In all the electric cutter of the present invention has the following advantages compared with the conventional manually operated ones, namely:

1. The ingeniously designed mutual movement of the eccentric shaft pin and stop hook makes the cutter to work reliably and securely.

2. Addition of the speed reduction gear unit contributes to increasing the cutting torque.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

1. The electric cutter comprising:
a housing provided with a power supply unit with a snap switch emerged out of the housing and electrically connected to the power supply unit;
a motor installed in the housing and electrically connected to the snap switch, wherein the snap switch is for controlling ON/OFF of the motor;
a speed reduction gear unit installed in the housing and jointed to an output shaft of the motor to amplify an output torque of the motor;
a rotating disc accommodated in the housing and having an eccentric shaft pin, wherein a center portion of the rotating disc is jointed to an output shaft of the speed reduction gear unit so as to rotate together therewith and drive the eccentric shaft pin simultaneously;
a cutter having two blades hinged crosswise like a pair of scissors, wherein one blade has a fixed terminal merged into the housing, and the other blade has another terminal also merged into the housing, having an extended movable arm with an end provided with a vertically produced stop hook mating the eccentric shaft pin; and
a compressed spring equipped straddling between the terminals of the two blades, whereby, when the rotating disc rotates, the eccentric shaft pin also revolves and reciprocates up and down with respect to the stop hook which in turn causes the eccentric shaft pin to actuate the movable arm of the cutter to make up and down cutting motion.

2. The electric cutter of claim 1, wherein the power supply unit is a battery unit or a rechargeable battery unit.

3. The electric cutter of claim 1, wherein the power supply unit provides AC electricity.

4. The electric cutter of claim 1, wherein the power supply unit, the snap switch, and the motor are electrically connected with conductors.

5. The electric cutter of claim 1, wherein an accommodation space is formed at the rear portion of the housing to accommodate the power supply unit, the accommodation space has a conductor blade provided on the top surface thereof to conduct the electricity by contacting an output terminal of the power supply unit.

6. The electric cutter of claim 1, wherein a terminal of one of the two blades is jointed with the speed reduction gear unit.
